(19) United States
(12) Patent Application Publication
(10) Pub. No.: US 2022/0242773 A1
(43) Pub. Date: Aug. 4, 2022

(54) METHODS FOR PRODUCING A HOLLOW-CORE FIBER AND FOR PRODUCING A PREFORM FOR A HOLLOW-CORE FIBER

(71) Applicant: HERAEUS QUARZGLAS GMBH & CO. KG, Hanau (DE)

(72) Inventors: Manuel Rosenberger, Hanau (DE); Michael Hünermann, Hanau (DE); Martin Trommer, Hanau (DE); Kay Schuster, Hanau (DE); Steffen Weimann, Hanau (DE); Oliver Ganz, Hanau (DE)

(21) Appl. No.: 17/625,952

(22) PCT Filed: Jul. 15, 2020
(86) PCT No.: PCT/EP2020/070016

§ 371 Date: Jan. 10, 2022

(30) Foreign Application Priority Data
Jul. 17, 2019 (EP) 19186858.7

(51) Int. Cl. C03B 37/012; C03B 37/027

(52) U.S. Cl. CPC C03B 37/0122; C03B 37/0124; G02B 6/02304; C03B 37/02781; C03B 37/01242; C03B 37/01245

(57) ABSTRACT

Methods are known for producing an anti-resonant hollow-core fiber which has a hollow core extending along a fiber longitudinal axis and an inner jacket region that surrounds the hollow core, said jacket region comprising multiple anti-resonant elements. The known methods have the steps of: providing a cladding tube that has a cladding tube inner bore and a cladding tube longitudinal axis along which a cladding tube wall extends that is delimited by an interior and an exterior; providing a number of tubular anti-resonant element preforms; arranging the anti-resonant element preforms at target positions of the interior of the cladding tube wall, thereby forming a primary preform which has a hollow core region and an inner jacket region; and elongating the primary preform in order to form the hollow-core fiber or further processing the primary preform in order to form a secondary preform. The aim of the invention is to achieve a high degree of precision and an exact positioning of the anti-resonant elements in a sufficiently stable and reproducible manner on the basis of the aforementioned methods. This is achieved by providing anti-resonant element preforms which have at least one respective ARE outer tube and/or at least one respective ARE inner tube, wherein the ARE outer tube and/or the ARE inner tube is produced using a vertical drawing method without molding tools.

### TECHNICAL BACKGROUND

The invention relates to a method for producing an anti-resonant hollow-core fiber comprising a hollow core extending along a longitudinal axis of the fiber and a sheath region surrounding the hollow core, which sheath region comprises a plurality of anti-resonance elements, comprising the method steps of:
(a) providing a cladding tube comprising an inner bore of the cladding tube and a longitudinal axis of the cladding tube along which a cladding tube wall delimited by an inner side and an outer side extends,
(b) providing a number of tubular anti-resonance element preforms,
(c) arranging the anti-resonance element preforms at desired positions of the inner side of the cladding tube wall to form a primary preform, which comprises a hollow core region and an inner sheath region, and
(d) elongating the primary preform to form the hollow-core fiber or further processing the primary preform into a secondary preform from which the hollow-core fiber is drawn, wherein the further processing comprises a single or repeated performance of one or more of the following hot-forming processes:
   (i) elongation,
   (ii) collapse,
   (iii) collapse and simultaneous elongation,
   (iv) collapse of additional sheath material,
   (v) collapse of additional sheath material and subsequent elongation,
   (vi) collapse of additional sheath material and simultaneous elongation.

The invention also relates to a method for producing a preform for an anti-resonant hollow-core fiber comprising a hollow core extending along a longitudinal axis of the fiber and a sheath region surrounding the hollow core, which sheath region comprises a plurality of anti-resonance elements, comprising the method steps of:
(a) providing a cladding tube comprising an inner bore of the cladding tube and a longitudinal axis of the cladding tube, along which a cladding tube wall delimited by an inner side and an outer side extends,
(b) providing a number of tubular anti-resonance element preforms,
(c) arranging the anti-resonance element preforms at desired positions on the inner side of the cladding tube wall to form a primary preform, which comprises a hollow core region and an inner sheath region, and
(d) optional further processing of the primary preform into a secondary preform for the hollow-core fiber, wherein the further processing comprises a single or repeated performance of one or more of the following hot-forming processes:
   (i) elongation,
   (ii) collapse,
   (iii) collapse and simultaneous elongation,
   (iv) collapse of additional sheath material,
   (v) collapse of additional sheath material and subsequent elongation,
   (vi) collapse of additional sheath material and simultaneous elongation.

Conventional single-mode optical fibers made of solid material have a core region made of glass, which is surrounded by a sheath region made of glass with a lower refractive index. Light guidance is based thereby on total reflection between the core and the sheath region. However, the interactions of the guided light with the solid material are associated with an increased latency in data transmission and relatively low damage thresholds with respect to high-energy radiation.

These disadvantages are prevented or reduced by “hollow-core fibers” in which the core comprises an evacuated cavity filled with gas or liquid. In hollow-core fibers, the interaction of the light with the glass is less than in solid-core fibers. The refractive index of the core is less than that of the sheath, so that light guidance by total reflection is not possible and the light would normally escape from the core into the sheath. As a function of the physical mechanism of the light guidance, hollow-core fibers are divided into “photonic bandgap fibers” and “anti-resonance reflection fibers.”

In the case of “photonic bandgap fibers,” the hollow core region is surrounded by a sheath in which small hollow channels are arranged periodically. On the basis of semiconductor technology, the periodic structure of the hollow channels in the sheath brings about the effect referred to as the “photonic bandgap,” according to which light of certain wavelength ranges scattered at the sheath structures can constructively interfere due to Bragg reflection in the central cavity and cannot propagate transversely in the sheath.

In the embodiment of the hollow-core fiber referred to as “anti-resonant hollow-core fiber” (ARHCF), the hollow core region is surrounded by an inner sheath region in which so-called “anti-resonant elements” (or “anti-resonance elements,” “AREs” for short) are arranged. The walls of the anti-resonance elements evenly distributed around the hollow core can act as Fabry-Perot cavities operated in anti-resonance, which reflect the incident light and guide it through the fiber core.

This fiber technology promises a low optical attenuation, a very broad transmission spectrum (even in the UV or IR wavelength ranges) and a low latency in data transmission.

Potential applications of the hollow-core fibers lie in the fields of data transmission, high-power beam guidance, for example for material processing, modal filtering, non-linear optics, in particular for super-continuum generation, from the ultraviolet to infrared wavelength range.

### PRIOR ART

A disadvantage of anti-resonant hollow-core fibers is that higher-order modes are not necessarily suppressed, so that they are often not exclusively single-mode over long transmission lengths and the quality of the output beam deteriorates.

In the paper by Francesco Poletti “Nested antiresonant nodeless hollow core fiber,” Optics Express, vol. 22, no. 20 (2014), DOI: 10.1364/OE 22.023807, a fiber design is proposed, with which anti-resonance elements are not designed as a simple singular structural element, but are composed of several nested structural elements. The nested anti-resonance elements are designed such that higher-order core modes, but not the fundamental core mode, are phase-matched to the sheath modes and are suppressed. As a result, the propagation of the fundamental core mode is always ensured, and the hollow-core fiber can be effectively single-mode over a limited wavelength range.

Effective mode suppression depends on the center wavelength of the transmitted light and on the structural parameters of the fiber design, such as the radius of the hollow core and the difference in the diameters of nested ring structures in the anti-resonance elements.

EP 3 136 143 A1 discloses an anti-resonant hollow-core fiber (referred to therein as “hollow-core fiber of non-bandgap type”), with which the core can conduct further modes in addition to the fundamental mode. For this purpose, it is surrounded by an inner sheath having “non-resonant elements,” which provide a phase-matching of anti-resonant modes with the higher modes. The hollow-core fiber is produced according to what is known as a “stack-and-draw technique”, by arranging the starting elements to form an axially parallel ensemble and fixing them to form a preform and then elongating the preform. In this case, a cladding tube with a hexagonal inner cross-section is used, and six so-called “ARE preforms” (anti-resonance element preforms) are fixed in the inner edges of the cladding tube. This preform is drawn in two stages to form a hollow-core fiber.

WO 2018/169487 A1 discloses a method for producing a preform for anti-resonant hollow-core fibers, with which a first sheath region comprises a plurality of rods and a second sheath region comprises a plurality of tubes surrounded by an outer cladding tube. Rods, tubes, and cladding tube are joined to form a preform by means of the “stack and draw” technique.

Before the preform is elongated, the preform end is sealed, which is done by applying a sealing compound. For example, a UV adhesive is used as the sealing compound.

### TECHNICAL OBJECT

Anti-resonant hollow-core fibers, and in particular those with nested structural elements, have complex internal geometries, which makes it difficult for them to be produced exactly and reproducibly. This applies all the more because, if the resonance or anti-resonance conditions are to be maintained, even small variations in dimensions in the order of magnitude of the operating wavelength of the light to be guided cannot be tolerated. Deviations from the desired geometry can be caused by the configuration of the fiber preform, and they can also occur through undesired deformations that are not true to scale in the fiber drawing process.

In the known “stack and draw” technique, many elements are to be joined together with positional accuracy. For example, in order to produce the hollow-core fiber known from the aforementioned paper in the “NANF” design, six anti-resonance element preforms, each consisting of an anti-resonance element outer tube (ARE outer tube, for short) and an anti-resonance element inner tube welded on one side to the inner surface of the ARE outer tube (ARE inner tube, for short) must be attached to the inner face of a cladding tube.

In order to achieve low attenuation values and broad transmission ranges, the azimuthal position of the anti-resonance elements within the cladding tube is also important in addition to a uniform wall thickness of the walls of the anti-resonance elements. This cannot be easily achieved with the “stack and draw” technique. The aim of the invention is to specify a method for the cost-effective production of an anti-resonant hollow-core fiber that avoids the limitations of conventional production methods.

In particular, it is the object of the invention to provide a method for producing an anti-resonant hollow-core fiber and a preform for anti-resonant hollow-core fibers, with which a high precision of the structural elements and an exact positioning of the anti-resonance elements in the fiber can be reproducibly achieved in a sufficiently stable and reproducible manner.

Moreover, disadvantages of the classic “stack and draw” technique, with which the required structural accuracies, in particular a uniform wall thickness of the anti-resonance elements and exact positioning in predetermined azimuthal positions, is not easy to achieve, are to be avoided if at all possible.

### SUMMARY OF THE INVENTION

With regard to the method for producing the anti-resonant hollow-core fiber, this object is achieved according to the invention starting from a method of the aforementioned genus in that anti-resonance element preforms are provided, each of which has at least one ARE outer tube and optionally at least one ARE inner tube, wherein the ARE outer tube and/or the ARE inner tube is produced using a vertical drawing process without a molding tool.

The starting point for producing the anti-resonant hollow-core fiber is a preform referred to herein as a “primary preform.” The production of the primary preform includes the installation and connection of anti-resonance element preforms to a cladding tube. The primary preform can be elongated to form the hollow-core fiber; however, as a rule, the primary preform is further processed to produce therefrom a preform referred to herein as a “secondary preform.”

Optionally, the hollow-core fiber is produced by elongating the secondary preform. Alternatively, the primary preform or the secondary preform are surrounded by one or more buffer tubes to form a coaxial ensemble of components, and the coaxial ensemble is elongated directly to form the hollow-core fiber. The general term “preform” is understood here to mean that component or that coaxial ensemble of components from which the hollow-core fiber is ultimately drawn.

The production of the preform comprises a number of method steps, with which starting elements of the hollow-core fiber are produced and positioned relative to one another, and at least one heat deformation step. Each of the starting elements and has a certain deviation from its desired geometry, and each step of positioning and forming inevitably leads to geometry deviations that add up into an absolute geometry error in the finished preform. In particular, the hot-forming of glass can lead to an undesired and non-reproducible deformation when there are even minimal deviations from an ideal, generally cylindrically symmetrical temperature profile of the heating zone.

For the production of the primary preform, anti-resonance elements are provided and used according to the method according to the invention, at least some, preferably all, of which are produced without a molding tool in a vertical drawing process.
A molding tool is understood here to mean, for example, a molding nozzle, a molding mandrel or another glass-blowing tool, which is brought into direct contact with the hot mass of glass during the molding process for the purpose of shaping it. Such molding tools are made of a high-temperature-resistant material, such as tungsten, and they are often the cause of contaminants in the glass. They can also cause damage to the surface of the drawn glass string due to contact with the hot glass mass.
Since the method according to the invention is a contactless shaping method, that is to say with no use of molding tools, all these disadvantages are avoided. ARE outer tubes or ARE inner tubes, which are characterized by high purity and a surface with little damage, are obtained. In particular, an ARE outer tube or an ARE inner tube made of quartz glass that contains a tungsten concentration of less than 2 ppb by weight is obtained.
With known methods for elongating a starting cylinder, the reshaping in a heating zone takes place with a horizontally oriented longitudinal axis of the starting cylinder. Such horizontal drawing methods are used in particular for elongating long tubes. Particles formed in the heating zone, for example made of metal, graphite, or SiC, can easily reach the hot glass mass by gravity. Such particles lead to a deterioration in both optical properties (absorption, refractive index) and mechanical properties (bubbles or particles) and as a rule lead to fiber breakage during the fiber-drawing process.
This effect does not occur with the vertical pulling method according to the invention, since due to gravity the particles formed in the heating zone drop to the side of the elongated drawn tube. ARE outer tubes or ARE inner tubes, which are characterized by a great absence of particles, are obtained.
In particular, after completion of the vertical drawing process, an ARE outer tube or an ARE inner tube with an outer surface that is free of particles larger than 0.005 mm is obtained.

Overall, ARE outer tubes and ARE inner tubes can thus be realized with a higher breaking strength (due to low particulate contamination) and an improved geometric accuracy, which also contributes to improved attenuation properties and bandwidth performance. The components can be produced with a tolerance of less than 0.1 mm in the wall thickness.

In a particularly preferred method variant, the vertical drawing method comprises the following method steps:
(aa) providing a hollow starting cylinder made of glass, which has a longitudinal cylinder axis and an outer cylinder surface and an inner cylinder surface,
(bb) a first elongation process, with which the hollow starting cylinder with a vertically oriented longitudinal axis is continuously fed into a first heating zone having a first heating zone length L_{H1}, softens therein in some regions, and an intermediate cylinder is pulled from the softened region without using a molding tool, (cc) a second elongation process, with which the intermediate cylinder or an elongated intermediate cylinder obtained from the intermediate cylinder by elongation is continuously fed into a second heating zone having a second heating zone length L_{H2}, softens therein in some regions, and a drawn tube with an outer diameter Tₐ and an inner diameter Tᵢ is pulled from the softened region without using a molding tool, wherein the following applies: L_{H2}<L_{H1} and Tₐ/Tᵢ<1.5, and
(dd) cutting to length of the drawn tube to make ARE outer tubes or ARE inner tubes.

The elongation process proceeds in this case in at least two steps and in at least two different drawing systems. The drawing systems used thereby differ in particular in the length of their heating zone. In a heating zone with a temperature profile that is constant in the vertical direction, this is understood to mean the heated length within which the temperature has its nominal setpoint value. In a heating zone with a temperature profile that is not constant in the vertical direction, the heating zone refers to the longitudinal section within which the temperature measured in degrees Celsius is at least 90% of the maximum drawing temperature.
The comparatively longer heating zone in the first elongation step contributes to a more homogeneous radial temperature distribution in the volume of the starting cylinder to be formed and enables a large material throughput. The first heating zone length L_{H1} is at least 200 mm and preferably between 250 and 400 mm.
The comparatively shorter heating zone in the second elongation step produces a steeper temperature gradient in the axial direction of the intermediate cylinder to be formed. This results in a relatively short drawing cone with a low drawing cone mass. As a result of the lower softened mass, its natural vibrations are in turn reduced, with the result of smaller dimensional variations in the pulled tube. The second, shorter hot zone length L_{H2} is at most 180 mm, and preferably between 50 and 150 mm.

With a particularly advantageous variant of the two-stage elongation process, the provision of the hollow starting cylinder according to method step (aa) comprises mechanically machining the cylinder surfaces in order to set the final dimensions of the hollow starting cylinder, comprising an outer diameter Cₐ of at least 90 mm, an inner diameter Cᵢ and a diameter ratio Cₐ/Cᵢ of less than 2.8.

The mechanical machining of the cylinder surfaces of the hollow starting cylinder preferably takes place by machining by cutting, drilling, milling, grinding, honing and/or polishing.

In comparison to other known forming techniques for hollow cylinder production using heat and pressure, these machining techniques provide more precise and finer structures, and they avoid contamination of surfaces by molding tools, such as nozzles, presses or fusion molds.

A comparatively large hollow cylinder with an outer diameter Cₐ of at least 90 mm, preferably at least 150 mm, and particularly preferably at least 180 mm, is used as the starting cylinder. The diameter ratio Cₐ/Cᵢ is a measure of the wall thickness of the starting cylinder.

This is advantageously pulled into a drawn tube having an outer diameter Tₐ in the range of 7 to 25 mm via the intermediate step of producing the at least one intermediate cylinder.

With a first method variant, the wall thickness of the drawn tube is preferably set to a value between 0.2 and 2 mm, preferably to a value between 0.22 and 1.2 mm, and the diameter ratio Tₐ/Tᵢ set to a value in the range from 1.02 and 1.14, preferably to a value in the range from 1.04 to 1.08.

With a second method variant, the wall thickness of the drawn tube is preferably set to a value between 0.2 and 2 mm, preferably to a value between 0.22 and 1.2 mm, and the diameter ratio Tₐ/Tᵢ set to a value in the range from 1.02 and 1.14, preferably to a value in the range from 1.04 to 1.08.

In particular with regard to the smoothest possible inner surface of the drawn tube, it has proven to be advantageous if the draw-down ratio in the totality of the elongation processes is set to a value in the range from 38 to 7800.

The draw-down ratio here refers to the ratio of the total cross-sectional areas of the drawn tube and the starting cylinder. It is a measure of the intensity/degree of the forming process.

A higher manufacturing productivity can also be achieved by using a large starting cylinder.

It has been found that the quality of the inner wall of the drawn tube depends upon the intensity of the forming process. An intensive forming process tends to lead to a better, smoother inner surface.

The contactless vertical drawing process can also advantageously be used for producing the cladding tube of the primary preform. The cladding tube is preferably characterized by a diameter in the range from 20 to 70 mm, preferably by an outer diameter in the range from 30 to 60 mm. This is a comparatively large outer diameter. In the prior art, the outer diameters of the secondary preforms are typically 4 to 6 mm. The production of hollow-core fibers on an industrial scale is thus hardly possible.

Since the absolute geometry error present during fiber drawing are scaled down more strongly as the diameter of the preform increases, a more precise production of the hollow-core fiber is thus made possible in principle. The larger the diameter, the slower the rate of advance during elongation and the longer the duration that each axial section of the preform is exposed to the high temperature of the heating zone. However, at too slow an advance rate during elongation, the structural elements of the anti-resonance element preforms will deform. With diameters below 20 mm, the thermal inertia of the preform is low, so that any temperature fluctuations in the heating zone will be more difficult to compensate.

In a preferred method variant, the arrangement of the anti-resonance element preforms and/or the elongation of the primary preform and/or the drawing of the hollow-core fiber comprises a fastening measure and/or a sealing measure using a sealing or bonding compound containing amorphous SiO₂ particles.

The sealing or bonding compound used for sealing or fastening contains amorphous SiO₂ particles, which are held, for example, in a dispersion liquid. This compound is applied between the surfaces to be bonded or sealed and is generally pasty during use. When dried at low temperature, the dispersion liquid is partially or completely removed and the compound solidified.

The sealing or bonding compound, and, in particular, the solidified SiO₂-containing sealing or bonding compound obtained after drying, satisfies the requirements for fastening and compacting.

The temperature required for drying is below 300° C., which facilitates compliance with the dimensional stability of the preform and avoids thermal impairments. Heating to higher temperatures around 800° C., for example during elongation of the preform to form the hollow-core fiber, results in further thermal solidification of the sealing or bonding compound, which is also suitable for forming opaque or transparent glass. This is done by sintering or vitrifying, wherein sintering to form opaque glass requires comparatively lower temperatures and/or short heating durations than vitrifying to complete transparency. The sealing or bonding compound can thus be completely compacted by heating and vitrified by heating in the hot-forming process.

In the hot-forming process, the sealing or bonding compound does not decompose and releases few impurities. It is thus characterized by thermal stability and purity in the hot-forming process and avoids deformations resulting from different thermal coefficients of expansion.

When the primary preform is being elongated and/or when the hollow-core fiber is being drawn, the sealing and bonding compound may also advantageously be used to seal open ends of the anti-resonance element preforms and/or individual structural elements of the anti-resonance element preforms and/or any annular gap between tube elements.

In this way, the individual components of the primary preform and/or secondary preform may be subjected to different internal pressures during elongation or during the fiber-drawing process.

The accuracy of the positioning of the preforms on the inner surface of the cladding tube is further improved by the inner side of the cladding tube and/or the outer side of the cladding tube and/or the inner side of the ARE outer tube and/or the outer side of the ARE outer tube being produced by machining, in particular by drilling, milling, grinding, honing and/or polishing

In comparison to other known forming techniques, said machining techniques provide more precise and finer structures by using heat and pressure, and they avoid contamination of surfaces by molding tools, such as nozzles, presses or fusion molds.

The machining preferably also comprises a structuring of the inner side of the cladding tube in the region of desired positions of the anti-resonance element preforms by providing it with a longitudinal structure extending in the direction of the longitudinal axis of the cladding tube. This longitudinal structure comprises, for example, longitudinal slots and/or longitudinal grooves in the inner wall of the cladding tube, which run parallel to the longitudinal axis of the cladding tube and which are preferably produced by drilling, sawing, milling, cutting or grinding.

The longitudinal structure extending in the direction of the longitudinal axis of the cladding tube serves as a positioning aid for the anti-resonance element preforms. It makes it easier for the anti-resonance element preforms to assume predetermined defined positions on the inner side of the cladding tube.

The accuracy of the positioning of the preforms on the inner side of the cladding tube is improved if the upper end-face ends of the structural elements are positioned in the desired position by means of a positioning template.

The positioning template has, for example, a shaft projecting into the inner bore of the cladding tube, which shaft is provided with holding elements in the form of a plurality of holding arms pointing radially outwards.

The structurally predetermined star-shaped arrangement of the holding elements facilitates the exact positioning of the anti-resonance element preforms in the respective desired positions and their fastening, for example by means of the sealing or bonding compound explained above. In this case, the positioning template is preferably used exclusively in the region of the end faces of the cladding tube, preferably in the region of both cladding-tube end faces.

A method has also proven effective with which, when the primary preform is elongated according to method step (d) and/or when the hollow-core fiber is drawn according to method step (e), a plurality of components of the preform made of quartz glass are heated together and softened, wherein the quartz glass of at least some of the preform components contains at least one dopant that lowers the viscosity of quartz glass.

Components of the primary preform include the cladding tube and the anti-resonance element preforms arranged therein. The secondary preform contains additional sheath material that is provided, for example, in the form of a buffer tube or a plurality of buffer tubes and collapses onto the primary preform or is drawn with it to form the hollow-core fiber.

Dopants used to lower the viscosity of quartz glass are preferably fluorine, chlorine and/or hydroxyl groups.

Doping makes it possible to adapt the thermal expansion coefficients of adjacent preform components in order to avoid or reduce stresses. It can also be used to reduce the thermal stability of a component to favor the stability of an adjacent component.

For example, it has proven to be advantageous if, at a measuring temperature of 1250° C., the quartz glass of the cladding tube has a viscosity at least 0.5 dPa·s higher, preferably a viscosity at least 0.6 dPa·s higher, than the quartz glass of additionally applied sheath material (if the viscosity is given as a logarithmic value in dPa·s).

In particular with regard to a low optical attenuation and a large optical transmission bandwidth of the hollow-core fiber, it has proven to be particularly advantageous for the anti-resonance elements to be arranged around the hollow core with an odd-numbered symmetry.

In a preferred method, the accuracy of the positioning of the preforms in the cladding tube is further improved in that tubular structural elements are provided, of which at least some have a wall thickness in the range of 0.2 and 2 mm, preferably a wall thickness in the range of 0.25 and 1 mm, and wherein a cladding tube with an external diameter in the range of 90 and 250 mm, and preferably with an external diameter in the range of 120 to 200 mm, is provided. These components each have a length of at least 1 m. They are relatively high-volume structural elements for forming anti-resonance elements. This simplifies handling. In addition, with a vertical arrangement of cladding tube and structural elements, gravitational force supports the parallelism and vertical alignment of the longitudinal axes of the structural elements when the structural elements are each positioned and fixed in the desired position at their upper face end; for example and preferably using the sealing or bonding compound explained in more detail above, and additionally or alternatively thereto, by means of the positioning template described in detail above.

With regard to the production of the preform for the hollow-core fiber, the aforementioned technical object is achieved according to the invention starting from a method of the aforementioned genus in that anti-resonance element preforms are provided, each of which has at least one ARE outer tube and optionally at least one ARE inner tube, wherein the ARE outer tube and/or the ARE inner tube is produced using a vertical drawing process without a molding tool.

For the production of the primary preform, anti-resonance elements are provided and used according to the method according to the invention, at least some, preferably all, of which are produced without a molding tool in a vertical drawing process. This method enables a more precise production of the hollow-core fiber. Measures for producing the preform are explained above in connection with the production of the hollow-core fiber, and these explanations are included herewith.

### Definitions

Individual method steps and terms of the above description are additionally defined below. The definitions form part of the description of the invention. That which is expressed in the description is definitive in the event of a factual contradiction between one of the following definitions and the remaining description.

Anti-Resonance Elements

The anti-resonance elements may be simple or nested structural elements of the hollow-core fiber. They have at least two walls that, when viewed from the direction of the hollow core, have a negative curvature (convex) or do not have a curvature (planar, straight). They generally consist of a material that is transparent to the working light, for example glass, in particular doped or undoped SiO₂, a plastic, in particular a polymer, a composite material or crystalline material.

Anti-Resonance Element Preform/Anti-Resonance Element Precursor

What are referred to as anti-resonance element preforms are components or constituents of the preform that essentially become anti-resonance elements in the hollow-core fiber by simple elongation during the fiber-drawing process. Components or constituents of the preform that become anti-resonance element preforms only upon forming or that become anti-resonance elements directly are referred to as anti-resonance element precursors. The anti-resonance element preforms may be simple or nested components to which additional positioning aids can be fixed. They are originally present in the primary preform.

Nested anti-resonance element preforms form nested anti-resonance elements in the hollow-core fiber. They are composed of an outer tube and at least one further structural element that is arranged in the inner bore of the outer tube. The further structural element can be a further tube which bears against the inner surface of the outer tube. The outer tube is referred to as an “anti-resonance element outer tube” or an “ARE outer tube” for short, and the further tube is referred to as an “anti-resonance element inner tube” or an “ARE inner tube” for short, or also as a “nested ARE inner tube.”

In the case of multi-nested anti-resonance element preforms, at least one further structural element, for example a third tube abutting against the inner surface of the nested ARE inner tube, can be arranged in the inner bore of the nested ARE inner tube. Where there are multi-nested anti-resonance element preforms, in order to distinguish between the multiple tubes that are arranged within the ARE outer tube, a distinction can optionally be made between “outer nested ARE inner tube” and “inner nested ARE inner tube.”

The term “cross-section” in conjunction with cylindrical anti-resonance element preforms and their cylindrical structural elements always refers to the cross-section perpendicular to the respective longitudinal axis of the cylinder, namely, unless otherwise indicated, the cross-section of the outer contour in tubular components (not the cross-section of the inner contour).

Further processing of the primary preform, in particular by hot-forming steps, can result in intermediate products, in which the original anti-resonance element preforms are present in a shape that has been modified compared to the original shape. The modified shape is also referred to herein as an anti-resonance element preform or as an anti-resonance element precursor.

Preform/Primary Preform/Secondary Preform/Core Preform (Cane)

The preform is the component from which the anti-resonant hollow-core fiber is drawn. It is a primary preform or a secondary preform produced by further processing of the primary preform. The primary preform can be present as an ensemble consisting of at least one cladding tube and preforms or precursors for anti-resonance elements that are loosely accommodated or firmly fastened therein. The further processing of the primary preform into a secondary preform from which the hollow-core fiber is drawn can comprise a single or repeated performance of one or more of the following hot-forming processes:

(i) elongation,

(ii) collapse,

(iii) collapse and simultaneous elongation,

(iv) collapse of additional sheath material,

(v) collapse of additional sheath material and subsequent elongation,

(vi) collapse of additional sheath material and simultaneous elongation.

A preform obtained by collapsing and/or elongating a primary preform is referred to in the literature as a cane. Typically, it is overlaid with additional sheath material before or during drawing of the hollow-core fiber.

Elongating/Collapsing

During elongation, the primary preform is lengthened. The lengthening can take place without simultaneous collapse. Elongation can take place true to scale, so that, for example, the shape and arrangement of components or constituents of the primary preform is reflected in the elongated end product. During elongation, however, the primary preform can also be drawn not true to scale and its geometry can be modified.

During collapse, an inner bore is narrowed or annular gaps between tubular components are closed or narrowed. Collapse is generally accompanied by elongation.

Hollow Core/Inner Sheath Region/Outer Sheath Region

The ensemble comprising at least one cladding tube and therein loosely accommodated or firmly fastened preforms or precursors for anti-resonance elements is also referred to herein as “primary preform.” The primary preform comprises the hollow core and a sheath region. This sheath region is also referred to as an “inner sheath region” if there is also an “outer sheath region” that has been produced, for example, by collapsing onto the ensemble, and if a distinction is to be made between said sheath regions. The terms “inner sheath region” and “outer sheath region” are also used for the corresponding regions in the hollow-core fiber or in intermediate products obtained by further processing of the primary preform.

The designation “inner side of the tube” is also used as a synonym for “inner surface of the tube” and the designation “outer side of the tube” is also used as a synonym for “outer surface of the tube.” The term “inner bore” in conjunction with a tube does not mean that the inner bore has been produced by a drilling process.

Machining

This refers to separating mechanical manufacturing methods for the separating processing of a workpiece, in particular turning, cutting, drilling, sawing, milling and grinding. This machining creates a longitudinal structure extending in the direction of the longitudinal axis of the cladding tube, which serves as a positioning aid for the anti-resonance element preforms. The longitudinal structure is accessible from the inner side of the cladding tube; it can also extend through the entire cladding tube wall to the outer side.

Particle Size and Particle Size Distribution

Particle size and particle size distribution of the SiO₂ particles are characterized using the D₅₀ values. These values are taken from particle size distribution curves showing the cumulative volume of SiO₂ particles as a function of the particle size. The particle size distributions are often characterized on the basis of the respective D₁₀, D₅₀ and D₉₀ values. In this case, the D₁₀ value characterizes the particle size that is not achieved by 10% of the cumulative volume of the SiO₂ particles, and accordingly, the D₅₀ value and the D₉₀ value characterize the particle sizes that are not achieved by 50% and by 90%, respectively, of the cumulative volume of the SiO₂ particles. The particle size distribution is determined by scattered light and laser diffraction spectroscopy according to ISO 13320.

### EXEMPLARY EMBODIMENT

The invention is explained in more detail below with reference to an exemplary embodiment and a drawing. The following are shown in schematic representation

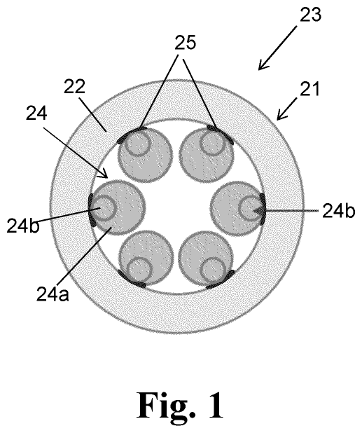

FIG. 1 a primary preform with a cladding tube and anti-resonance element preforms positioned and fastened therein for producing a preform for a hollow-core fiber, based on a view of the radial cross-section, and

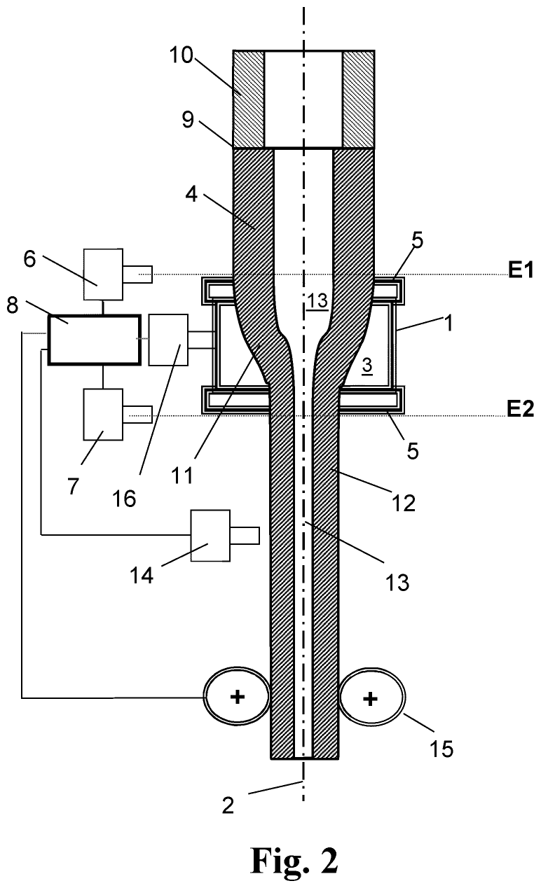

FIG. 2 a device for use in the tool-free production of ARE outer tubes and ARE inner tubes by means of a vertical drawing process.

In the production of the hollow-core fiber or the preform for the hollow-core fiber, a plurality of components are to be connected together. In addition, it can be helpful to seal existing gaps or channels of the preform when carrying out hot-forming processes. For bonding or sealing, a sealing or bonding compound based on SiO₂ and as disclosed in DE 10 2004 054 392 A1 is used. In this case, an aqueous slip containing amorphous SiO₂ particles having a particle size distribution characterized by a D₅₀ value of about 5 μm and by a D₉₀ value of about 23 μm is produced by wet-milling silica glass grain. Further amorphous SiO₂ grains with an average grain size of about 5 μm are mixed with the base slip. The slip used as a bonding compound has a solid content of 90%, which consists of at least 99.9 wt. % SiO₂.

FIG. 1 schematically shows a primary preform 23 with a cladding tube 21 having a cladding tube wall 22, on the inner surface of which are fastened equidistantly spaced anti-resonance element preforms 24 at previously defined azimuthal positions; in the exemplary embodiment, there are six preforms 24; in another preferred embodiment (not shown), there is an odd number of preforms.

The inner cladding tube 21 consists of quartz glass and has a length of 1000 mm, an outer diameter of 27 mm and an inner diameter of 20 mm. The anti-resonance element preforms 24 are present as an ensemble of nested structural elements consisting of an ARE outer tube 24a and an ARE inner tube 24b. The ARE outer tube 24a has an outer diameter of 6.2 mm and the ARE inner tube 24b has an outer diameter of 2.5 mm. The wall thickness of both structural elements (24a; 24b) is the same and is 0.3 mm. The diameter ratio in the ARE outer tube is thus 1.107 and in the ARE inner tube it is 1.315. The lengths of ARE outer tube 24a and ARE inner tube 24b correspond to the length of the cladding tube.

The anti-resonance element preforms 24 are fastened to the inner wall of the cladding tube 21 by means of the bonding compound 25 based on SiO₂.

The bonding compound 25 is applied locally to the inner surface of the cladding tube in the region of the end-face ends, and the anti-resonance element preforms 24 are placed thereon using a positioning template with a structurally predetermined star-shaped arrangement of holding arms for the individual anti-resonance element preforms 24. In this case, the positioning template is limited to the region around the two end-face ends of the cladding tube.

This method creates a precise and reproducible connection between the cladding tube 21 and the anti-resonance element preforms 24. Solidification of the bonding compound 25 at a low temperature is sufficient for fastening, so that an intense heating of the surrounding regions and thus a deformation of anti-resonance element preforms 24 is avoided.

The temperature required for drying is below 300° C., which facilitates compliance with the dimensional stability of the preform and avoids thermal impairments. Heating to higher temperatures around 800° C., for example during elongation of the preform to form the hollow-core fiber, results in further thermal solidification of the sealing or bonding compound 25, which is also suitable for forming opaque or transparent glass. This is done by sintering or vitrifying, wherein sintering to form opaque glass requires comparatively lower temperatures and/or short heating durations than vitrifying up until complete transparency. The sealing or bonding compound 25 can thus be completely compacted by heating and vitrified by heating in the hot-forming process. The sealing or bonding compound behaves like quartz glass; it becomes viscous and deformable.

The primary preform 23 is covered with a buffer tube made of quartz glass, wherein the buffer tube collapses onto the cladding tube 1, and at the same time, the tube ensemble is elongated to form a secondary preform. The buffer tube has an outer diameter of 63.4 mm and a wall thickness of 17 mm.

In the collapse and elongation process, the coaxial arrangement of the cladding tube 1 and the buffer tube coming from below in a vertically oriented longitudinal axis is fed into a temperature-controlled heating zone and softens therein zone-by-zone starting with the upper end of the arrangement.

The heating zone is kept at a desired temperature of 1600° C. with a control accuracy of +/−0.1° C. Temperature fluctuations in the hot-forming process can thereby be limited to less than +/−0.5° C.

The secondary preform formed in the collapse and elongation process has an outer diameter of approximately 50 mm and a sheath wall thickness of 16.6 mm composed of an outer sheath and an inner sheath. The maximum wall thickness variation (greatest value minus smallest value) of the anti-resonance element preforms is less than 4 μm. The secondary preform is subsequently drawn into the anti-resonant hollow-core fiber.

The following table lists the drawing parameters for different outer diameters before (BEFORE) and after (AFTER) the forming process (collapsing and elongation).

TABLE 1

| Outer diameter | Outer diameter | Cladding tube | Feed rate | Drawing |
|---|---|---|---|---|
| BEFORE [mm] | AFTER [mm] | length [mm] | [mm/min] | [mm/min] |
| 90 | 70 | 1000 | 15 | 9.80 |
| 80 | 70 | 1000 | 15 | 4.59 |
| 40 | 20 | 1000 | 5 | 15 |
| 25 | 20 | 1000 | 10 | 5.63 |

The heating zone has a length of 100 mm. For example, a cladding tube having an outer diameter of 90 mm and a wall thickness of 10 mm at a feed rate of 5 mm/min results in a throughput of 27.6 g/min into the heating zone; at a feed rate of 15 mm/min, the throughput is 83 g/min. At a feed rate of 15 mm/min, a throughput of 2.49 g/min results in the case of a tube with an outer diameter of 25 mm and 1 mm wall thickness.

The maximum deviation of the wall thickness of the anti-resonance element preforms in the preform is about 4 μm in all exemplary embodiments. Hollow-core fibers having outer diameters of 200 μm and 230 mm respectively were drawn from the preforms, as indicated in the table above, and the wall thicknesses of the anti-resonance elements determined.

The device shown in FIG. 2 serves for the tool-free elongation of an starting cylinder 4 of undoped quartz glass to form an intermediate cylinder.

The outer wall of the starting cylinder 4 is coarsely ground by means of a peripheral grinder equipped with a #80 grinding stone, whereby the predetermined desired outer diameter is essentially obtained. The outer surface is then finely ground by means of an NC peripheral grinder. The inner surface of the tube thus obtained is honed as a whole by means of a honing machine equipped with a #80 honing stone, wherein the degree of smoothing is continuously refined, and final treatment is carried out with a #800 honing stone. The starting cylinder 4 is then briefly etched in a 30% hydrofluoric acid etching solution. In this way, a starting cylinder 4 with an outer diameter of 200 mm and an inner diameter of 70 mm is produced. This is then elongated in a device according to FIG. 2 to form an intermediate cylinder 12.

The device comprises a vertically oriented resistance heating tube 1 made of graphite, which encloses a heating chamber 3 that is circular in cross-section. The heating tube 1 consists of an annular element with an inner diameter of 240 mm, an outer diameter of 260 mm and a length of 200 mm. The heating tube 1 surrounds the actual heating zone. At each end it is extended by means of 55 mm wide extension pieces 5 made of graphite tubing, which have an inner diameter of 250 mm and an outer diameter of 280 mm. The internal volume of the heating zone Vc is approximately 8140 mm³.

pyrometer 6, which detects the surface temperature of the starting cylinder 1, is arranged at the level of an upper detection plane E1 (at the upper edge of the upper extension piece 5). A further pyrometer 7, which detects the surface temperature of the elongated drawn tube 12, is arranged at the level of an lower detection plane E2 (at the lower edge of the lower extension piece 5). The temperature measurement values of the pyrometers 6 and 7 and the temperature of the heating tube 1 measured by the pyrometer 16 are each fed to a computer 8.

The upper end of the starting cylinder 4 is connected via a welded connection 9 to a quartz-glass holding tube 10, by means of which it can be shifted in the horizontal and vertical directions.

The starting cylinder 4 is aligned such that its longitudinal axis runs as coaxially as possible with the center axis 2 of the heating tube 1. It is fed from above into the heating chamber 3 (starting with its lower end) at a constant feed rate and softened therein. An intermediate-cylinder tube 12 is drawn vertically downward from the softened region, whereby a drawing cone 11 forms. The intermediate-cylinder tube 12 is guided past a wall-thickness measuring device 14, which is also connected to the computer 8, so that during the drawing process, the wall thickness of the drawn tube 12 being drawn out can be recorded and evaluated with the aid of the computer 8. The continuous inner bore of the starting cylinder 4 and intermediate-cylinder tube 12 has reference number 13. The tube drawing rate is detected by means of a discharge 15 and adjusted via the computer 8.

In the vertically oriented heating tube 1, the quartz glass starting cylinder 4 with an outer diameter of 200 mm and an inner diameter of 75 mm is adjusted in such a way that its longitudinal axis runs coaxially with the center axis 2 of the heating tube 1. The starting cylinder 4 is heated in the heating zone 3 to a temperature above 2200° C. and discharged at a predetermined rate of advance. From the drawing cone 11 that forms, the quartz glass drawn tube 12 is drawn at a regulated drawing speed to a nominal outer diameter of 40 mm and an inner diameter of 30 mm (wall thickness: 5 mm) as an intermediate cylinder. This has a smooth, melted and particle-free surface.

In a second elongation step, it is used in a second drawing system as a starting cylinder for the production of ARE outer tubes or ARE inner tubes. The second drawing system used for this purpose is the same as the one in FIG. 2; differing essentially in the length and the inner diameter of its heating zone. The heating zone (the heating tube) has an inner diameter of 120 mm, an outer diameter of 140 mm and a length of 100 mm.

1. Method for producing an anti-resonant hollow-core fiber comprising a hollow core extending along a longitudinal axis of the fiber and an inner sheath region surrounding the hollow core, which sheath region comprises a plurality of anti-resonance elements, comprising the method steps of:
(a) providing a cladding tube (21) comprising an inner bore of the cladding tube and a longitudinal axis of the cladding tube, along which a cladding tube wall (22) delimited by an inner side and an outer side extends,
(b) providing a number of tubular anti-resonance element preforms (24),
(c) arranging the anti-resonance element preforms (24) at desired positions on the inner side of the cladding tube wall (22) to form a primary preform (23), which comprises a hollow core region and an inner sheath region, and
(d) elongating the primary preform (23) to form the hollow-core fiber or further processing the primary preform (23) into a secondary preform from which the hollow-core fiber is drawn, wherein the further processing comprises a single or repeated performance of one or more of the following hot-forming processes:
(i) elongation,
(ii) collapse,
(iii) collapse and simultaneous elongation,
(iv) collapse of additional sheath material,
(v) collapse of additional sheath material and subsequent elongation,
(vi) collapse of additional sheath material and simultaneous elongation,
characterized in that anti-resonance element preforms (24) are provided, each of which has at least one ARE outer tube (24a) and optionally at least one ARE inner tube (24b), wherein the ARE outer tube (24a) and/or the ARE inner tube (24b) is produced by means of a vertical drawing process without using a molding tool.

2. Method according to claim 1, characterized in that the vertical drawing method comprises the following method steps:
(aa) providing a hollow starting cylinder (4) made of glass, which has a longitudinal cylinder axis (2) and an outer cylinder surface and an inner cylinder surface,
(bb) a first elongation process, with which the hollow starting cylinder (4) with a vertically oriented longitudinal axis (2) is continuously fed into a first heating zone (3) having a first heating zone length L_{H1}, softens therein in some regions, and an intermediate cylinder (12) is pulled from the softened region without using a molding tool,
(cc) a second elongation process, with which the intermediate cylinder (12) or an elongated intermediate cylinder obtained from the intermediate cylinder (12) by elongation is continuously fed into a second heating zone having a second heating zone length L_{H2}, softens therein in some regions, and a drawn tube with an outer diameter Tₐ and an inner diameter Tᵢ is pulled from the softened region without using a molding tool, wherein the following applies: L_{H2}<L_{H1} and Tₐ/Tᵢ<1.5, and
(dd) cutting to length of the drawn tube to make ARE outer tubes (24a) or ARE inner tubes (24b).

3. Method according to claim 2, characterized in that the provision of the hollow starting cylinder (4) according to method step (aa) comprises mechanically machining the cylinder surfaces in order to set the final dimensions of the hollow starting cylinder, comprising an outer diameter Cₐ of at least 90 mm, an inner diameter Cᵢ and a diameter ratio Cₐ/Cᵢ of less than 2.8.

4. Method according to claim 3, characterized in that the mechanical machining of the cylinder surfaces of the hollow starting cylinder (4) takes place by cutting, milling, drilling, grinding, honing and/or polishing.

5. Method according to claim 3 or 4, characterized in that the outer diameter Cₐ is set to at least 150 mm, preferably to at least 180 mm.

6. Method according to any one of claims 2 to 5, characterized in that the drawn tube is drawn with an outer diameter Tₐ in the range from 7 to 35 mm.

7. Method according to any one of claims 2 to 6, characterized in that the first heating zone length L_{H1} is at least 200 mm, and preferably between 150 and 400 mm, and that the second heating zone length L_{H2} is at most 140 mm, and preferably between 50 and 140 mm.

8. Method according to any one of claims 2 to 7, characterized in that the wall thickness of the drawn tube is set to a value between 0.2 and 2 mm, preferably to a value between 0.22 and 1.2 mm, and that the diameter ratio Tₐ/Tᵢ is set to a value in the range from 1.02 and 1.14, preferably to a value in the range from 1.04 to 1.08.

9. Method according to any one of claims 2 to 7, characterized in that the wall thickness of the drawn tube is set to a value between 0.2 and 2 mm, preferably to a value between 0.22 and 1.2 mm, and that the diameter ratio Tₐ/Tᵢ is set to a value in the range from 1.05 and 1.5, preferably to a value in the range from 1.14 to 1.35.

10. Method according to any one of claims 2 to 8, characterized in that the draw-down ratio in the totality of elongation processes is set to a value in the range from 38 to 78.

11. Method according to any one of the preceding claims, characterized in that the ARE outer tube (24a) or the ARE inner tube (24b) has an outer surface, and that, after completion of the vertical drawing process, the outer surface is free of particles larger than 0.005 mm, and that the ARE outer tube (24a) or the ARE inner tube (24b) consists of quartz glass containing a tungsten concentration of less than 2 ppb by weight.

12. Method for producing a preform for an anti-resonant hollow-core fiber comprising a hollow core extending along a longitudinal axis of the fiber and an inner sheath region surrounding the hollow core, which sheath region comprises a plurality of anti-resonance elements, comprising the method steps of:
(a) providing a cladding tube (21) comprising an inner bore of the cladding tube and a longitudinal axis of the cladding tube, along which a cladding tube wall (22) delimited by an inner side and an outer side extends,
(b) providing a number of tubular anti-resonance element preforms (24),
(c) arranging the anti-resonance element preforms (24) in desired positions on the inner side of the cladding tube wall (22) to form a primary preform (23), which comprises a hollow core region and an inner sheath region, and
(d) optionally further processing the primary preform (23) into a secondary preform for the hollow-core fiber, wherein the further processing comprises a single or repeated performance of one or more of the following hot-forming processes:
(i) elongation,
(ii) collapse,
(iii) collapse and simultaneous elongation,
(iv) collapse of additional sheath material,
(v) collapse of additional sheath material and subsequent elongation,
(vi) collapse of additional sheath material and simultaneous elongation,
characterized in that anti-resonance element preforms (24) are provided, each of which has at least one ARE outer tube (24a) and optionally at least one ARE inner tube (24b), wherein the ARE outer tube (24a) and/or the ARE inner tube (24b) is produced by means of a vertical drawing process without using a molding tool.
